(19) United States
(12) Patent Application Publication
(10) Pub. No.: US 2012/0197670 A1
(43) Pub. Date: Aug. 2, 2012

(54) ONLINE RESTAURANT SYSTEMS FOR FORECASTING BEHAVIORS OF LATE CUSTOMERS

(76) Inventor: TAI CHEUNG POON, HONG KONG (HK)

(21) Appl. No.: 13/015,820

(22) Filed: Jan. 28, 2011

(51) Int. Cl. G06Q 10/00; G06Q 30/00

(52) U.S. Cl. 705/5; 705/1.1

(57) ABSTRACT

This invention is provided to forecast behaviors of late customers. In one embodiment, a system including a plurality of mobile equipments is provided. In the embodiment, the system includes a mobile equipment of a first customer and a mobile equipment of a second customer. The system also includes an apparatus comprising a computing processing unit configured to process memory units stored to execute instructions by the processing unit.

### FIELD OF THE INVENTION

This invention generally relates to the field customer forecasting. Specifically, but not limited to, this invention relates to reserving a table for use at a first reservation time by the first customer using the first mobile equipment. This invention further relates to determining if the first customer will be late as part of a process of dynamic Late Customers Forecasting, based on a set of criterion, including a history of the first customer. Moreover, at a time when the first reservation time is fast approaching, refining the process of dynamic Late Customers Forecasting by re-determining if the first customer will be late, based on the set of criterion, this invention includes not only the history of the first customer but also a current location of the first customer. This invention then determines, if the first customer has been forecasted to be late, how long the first customer will be late at the time when the first reservation time is approaching. This invention further sends repeated warnings to the first customer, if the first customer has been forecasted to be late. If the first customer has been forecasted to be late, this invention contacts the second customer through the mobile equipment of the second customer to make a different appointment with the second customer in order to avoid unnecessary delay introduced by the first customer.

### BACKGROUND OF THE INVENTION

In order to position themselves as premier restaurants, many restaurants offering reservations or bookings in advance. To make a booking or reservation, an individual simply provides the time of the booking, as well as the number of persons joining the meal. The restaurant usually does not require the individual making the reservation request to provide any other information, such as background information or even the history of the individual who has made similar transactions with the restaurant in the past. Thus, restaurants know very little about the persons who are making reservations for tables.

The advent of computer systems provides easy access to reservation systems. With, for example, a personal computer, a person who wants to make reservation of a table can easily ensure whether the table is available at a given time. When the time comes, the table would be made available by the restaurant, as expected by those who make the reservations.

Therefore, expectation is high as far as restaurants are concerned. However, the expectation for the customers who have reserved tables tends to be low. A restaurant would be fortunate if those who reserved can arrive on time. The reality is, late arrival is rather common. When that happens, the restaurant is put in a difficult situation. On one hand, the restaurant would not want to keep a table idle for an extended amount of time. Doing so would cause the restaurant lost revenue. On the other hand, the restaurant would not offend customers. When the late customers come, it would be difficult for the restaurants to turn the customers away. Therefore, able to accurately to predict late customers dynamically are necessarily. There is a need to predict and notify restaurants promptly when there are signs of late arrivals have shown.

Late arrivals can put restaurants in difficult positions, as shown above. Even worse, if the customer who has reserved the table fails to show up completely, the table reserved for that customer would have been sitting idle for the entire night.

In view of the foregoing, there is a need to know the customers extensively, even in the restaurant business. There are certain customers that come more often to a given restaurant. Those customers may include those who reserve often and arrive on time on a regular basis. Additionally, because of the impact of late arrivals, there is a need for restaurants to provide incentives as well as penalties to those who come on time and those who fail to come on time.

### SUMMARY OF THE INVENTION

An online restaurant system is provided for forecasting behaviors of late customers. According to an embodiment, the system comprises a mobile equipment of a first customer and a mobile equipment of a second customer. The embodied system further includes an apparatus comprising a computing processing unit configured to process memory units stored to execute instructions by the processing unit.

Instructions of the embodied system include reserving a table for use at a first reservation time by the first customer using the first mobile equipment. The system may determine if the first customer will be late as part of a process of dynamic Late Customers Forecasting, based on a set of criterion, including a history of the first customer. At a time when the first reservation time is fast approaching, the embodied system may refine the process of dynamic Late Customers Forecasting by re-determining if the first customer will be late, based on the set of criterion, including not only the history of the first customer but also a current location of the first customer. In one aspect of the system, the first customer may be determined if he or she has been forecasted to be late, and how long the first customer will be late at the time when the first reservation time is approaching. If the first customer has been forecasted to be late, repeated warnings may be sent to the first customer.

Besides, the restaurant may contact the second customer through the mobile equipment of the second customer to make a different appointment with the second customer in order to avoid unnecessary delay introduced by the first customer, wherein the second customer has reserved the table for use at a time later than the first reservation time.

In accordance to a different embodiment, additional charges may be applicable to customers who have made the reservations. In one implementation, after the inventive system has accepted the reservation, the system may send a notification to remind the first customer that when a customer is late. Further, additional charges may be incurred to the late customer as additional tips even though no penalties will be assessed directly to the first customer for being late. The additional changes may be assessed as additional tips to be included in the warnings. When the first customer later arrives at the restaurant and determined to be actually late, the system would at that point charge the first customer for being late as additional tips.

In yet another implementation, an inventive system includes reserving the table for use at a second reservation time by the second customer using the second mobile equipment before accepting the reservation by the first customer. In the embodiment, the inventive system determines whether the reservation by the first customer has been forecasted not only to be late, but to be effectively cancelled, based on the current location of the first customer and time remaining from the reservation time by the first customer. The system may also send a notification to the first customer, if the reservation by the first customer has been forecasted to be effectively cancelled, wherein the notification confirms the cancellation of the reservation made by the first customer. If the reservation by the first customer has been conformed to be actually cancelled, the system then contact the second customer through the mobile equipment of the second customer to incent the second customer to come earlier by offering the second customer a reduction of tips in exchange to come earlier than originally reserved.

In yet another embodiment, at a time when the first reservation time is fast approaching, the system may optionally calculate, based on the prompted location, distance between the current location of the first customer and the location of the restaurant. Further, the system may estimate, in a range, time for the first customer to arrive from the current location to the restaurant. If the estimated time to arrive at restaurant is later than the reserved time, then the first customer is deemed to be a late customer. If the estimated time to arrive at restaurant is much later than the reserved time, then the first customer is deemed to be effectively a ‘cancelled customer.’ The system may then send a notification to the first customer, if the reservation by the first customer has been forecasted to be effectively cancelled, wherein the notification confirms the cancellation of the reservation made by the first customer; and if the reservation by the first customer has been conformed to be actually cancelled, the system may contact the second customer through the mobile equipment of the second customer to incent the second customer to come earlier by offering the second customer a reduction of tips in exchange to come earlier than originally reserved.

In another embodiment, at a time when the first reservation time is fast approaching, the reservation system may prompt the first mobile equipment of the first customer for the current location of the first customer using GPS technologies and satellite communications exclusively without relying on GPRS and other means of cellular communications, wherein if current GPS signals are not available because the first mobile equipment is being used in an indoor environment, location of last GPS signals before the first mobile equipment entering the indoor environment must be recorded previously by the first mobile equipment and is now reported in response to the prompting by the apparatus.

If the reservation by the first customer has been conformed to be actually cancelled, the reservation system would contact the second customer and third customer through the mobile equipment of the second customer to incent both the second customer and the third customer to come earlier by offering the second customer and the third customer a reduction of tips in exchange to come earlier than originally reserved. If both the second customer and the third customer indicate their interests to accept the proposed reserved time, the reservation system would allow both the second customer and the third customer to bid for the proposed reserved time; and reduce the incentive further to attract either the second customer or the third customer who is willing to accept the proposed reserved time with the lowest incentive.

### BRIEF DESCRIPTION OF THE DRAWINGS

FIG. 1 illustrates an exemplary reservation system for forecasting behaviors of late customer.

FIG. 2 is a flow chart depicting an embodiment of the invention for forecasting behaviors of late customers.

### DETAILED DESCRIPTION

Systems and methods are provided for forecasting behaviors of late customers. Embodiments of the inventions may include various means of forecasting based on network connectivity, attended/unattended status, or a combination thereof.

The features of this invention are explained in the context of a restaurant reservation system as described below. This embodiment is but one of many and is not intended to be limiting in any way.

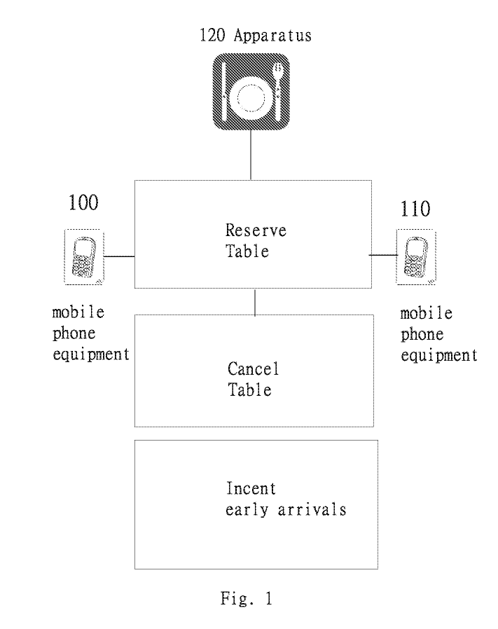

FIG. 1 depicts an online restaurant system for forecasting behaviors of late customers. The system includes a mobile equipment of a first customer 100, a mobile equipment of a first customer 110, and an apparatus 120. The apparatus 120 comprises a computing processing unit configured to process memory units stored to execute instructions by the processing unit.

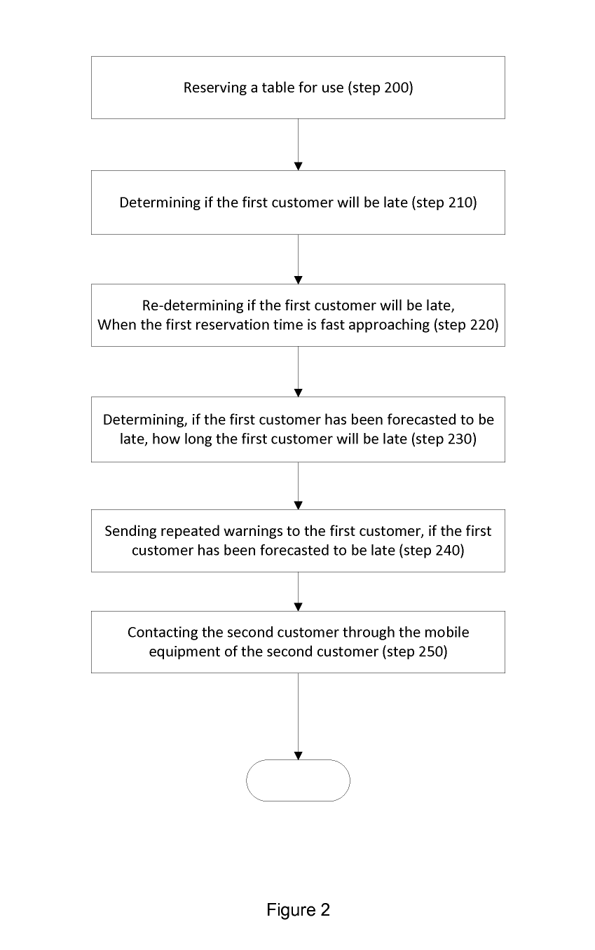

Referring to FIG. 2 for certain aspects of an embodiment, the instructions comprise reserving a table for use at a first reservation time by the first customer using the first mobile equipment (step 200). The instructions include determining if the first customer will be late as part of a process of dynamic Late Customers Forecasting, based on a set of criterion, including a history of the first customer (step 210). At a time when the first reservation time is fast approaching, the process of dynamic Late Customers Forecasting is refined by re-determining if the first customer will be late, based on the set of criterion, including not only the history of the first customer but also a current location of the first customer (step 220). The first customer is determined if it has been forecasted to be late, and how long the first customer will be late at the time when the first reservation time is approaching (step 230).

Furthermore, repeated warnings can be sent to the first customer (step 240), if the first customer has been forecasted to be late; and if the first customer has been forecasted to be late, contacting the second customer through the mobile equipment of the second customer to make a different appointment with the second customer in order to avoid unnecessary delay introduced by the first customer, wherein the second customer has reserved the table for use at a time later than the first reservation time (step 250).

The inventive system can be further implemented to handle late arrivals of customers. In one embodiment, the online restaurant can be implemented to allow reservation of a table for use at a first reservation time by the first customer using a first mobile equipment. The embodied system may allow acceptance of the reservation by the first customer. After accepting the reservation, the system may allow sending a notification to remind the first customer that when a customer is late, additional charges will be incurred to the late customer as additional tips even though no penalties will be assessed directly to the first customer for being late. Additionally, the inventive system allows determining if the first customer will be late as part of a process of dynamic Late Customers Forecasting, based on a set of criterion, including a history of the first customer. At a time when the first reservation time is fast approaching, the inventive system may allow refining the process of dynamic Late Customers Forecasting by re-determining if the first customer will be late, based on the set of criterion, including not only the history of the first customer but also a current location of the first customer. Furthermore, the inventive system may allow determining, if the first customer has been forecasted to be late, how long the first customer will be late at the time when the first reservation time is approaching; and sending repeated warnings to the first customer, if the first customer has been forecasted to be late, wherein the warnings include the additional charges to be assessed as additional tips.

If the first customer has been forecasted to be late, the inventive system permits contacting the second customer through the mobile equipment of the second customer to make a different appointment with the second customer in order to avoid unnecessary delay introduced by the first customer, wherein the second customer has reserved the table for use at a time later than the first reservation time (step 200). When, however, the first customer arrives at the restaurant and determined to be actually late, an inventive feature allows charging the first customer for being late as additional tips.

In another embodiment of the present invention, additional features can be included to allow reservations as well as cancellations of the pre-determined reservations. In one example, an inventive system allows reserving a table for use at a first reservation time by the first customer using the first mobile equipment; reserving the table for use at a second reservation time by the second customer using the second mobile equipment; and accepting the reservation by the first customer. Further, the inventive system may feature accepting the reservation by the second customer. After accepting the reservation, the system may send a notification to remind the first customer that when a customer is late, additional charges will be incurred to the late customer as additional tips even though no penalties will be assessed directly to the first customer for being late. Moreover, the inventive system may determine if the first customer will be late as part of a process of dynamic Late Customers Forecasting, based on a set of criterion, including a history of the first customer. At a time when the first reservation time is fast approaching, the system can refine the process of dynamic Late Customers Forecasting by re-determining if the reservation by the first customer will be late, based on the set of criterion, including not only the history of the first customer but also a current location of the first customer.

Further features of this embodiment may include determining whether the reservation by the first customer has been forecasted not only to be late, but to be effectively cancelled, based on the current location of the first customer and time remaining from the reservation time by the first customer. More, the inventive system can send a notification to the first customer, if the reservation by the first customer has been forecasted to be effectively cancelled, wherein the notification confirms the cancellation of the reservation made by the first customer. If the reservation by the first customer has been conformed to be actually cancelled, the system may contact the second customer through the mobile equipment of the second customer to incent the second customer to come earlier by offering the second customer a reduction of tips in exchange to come earlier than originally reserved.

In accordance with another implementation, additional features are provided to the restaurant. In one aspect of the invention, the inventive system supports reserving a table for use at a first reservation time by the first customer using the first mobile equipment; reserving the table for use at a second reservation time by the second customer using the second mobile equipment; accepting the reservation by the first customer; and accepting the reservation by the second customer.

After accepting the reservation, the system of this example may support sending a notification to remind the first customer that when a customer is late, additional charges will be incurred to the late customer as additional tips even though no penalties will be assessed directly to the first customer for being late; and determining if the first customer will be late as part of a process of dynamic Late Customers Forecasting, based on a set of criterion, including a history of the first customer. At a time when the first reservation time is fast approaching, the inventive system may support refining the process of dynamic Late Customers Forecasting by re-determining if the reservation by the first customer will be late, based on the set of criterion, including not only the history of the first customer but also a current location of the first customer.

The inventive system may also support calculating, based on the prompted location, distance between the current location of the first customer and the location of the restaurant; and estimating, in a range, time for the first customer to arrive from the current location to the restaurant. If the estimated time to arrive at restaurant is later than the reserved time, then the first customer is deemed to be a late customer. If the estimated time to arrive at restaurant is much later than the reserved time, then the first customer is deemed to be effectively a ‘cancelled customer.’ The inventive system may support sending a notification to the first customer, if the reservation by the first customer has been forecasted to be effectively cancelled. The notification can confirm the cancellation of the reservation made by the first customer. If the reservation by the first customer has been conformed to be actually cancelled, the system may allow contacting the second customer through the mobile equipment of the second customer to incent the second customer to come earlier by offering the second customer a reduction of tips in exchange to come earlier than originally reserved.

In another aspect of the present invention, an online restaurant system is provided. After accepting the reservation, the system may support sending a notification to remind the first customer that when a customer is late, additional charges will be incurred to the late customer as additional tips even though no penalties will be assessed directly to the first customer for being late. The system may further determining if the first customer will be late as part of a process of dynamic Late Customers Forecasting, based on a set of criterion, including a history of the first customer.

At a time when the first reservation time is fast approaching, the inventive system may allow refining the process of dynamic Late Customers Forecasting by re-determining if the reservation by the first customer will be late, based on the set of criterion, including not only the history of the first customer but also a current location of the first customer. The system may further allows prompting the first mobile equipment of the first customer for the current location of the first customer using GPS technologies and satellite communications exclusively without relying on GPRS and other means of cellular communications; and calculating, based on the prompted location, distance between the current location of the first customer and the location of the restaurant.

The inventive system may further estimate, in a range, time for the first customer to arrive from the current location to the restaurant. If the estimated time to arrive at restaurant is later than the reserved time, then the first customer is deemed to be a late customer. If the estimated time to arrive at restaurant is much later than the reserved time, then the first customer is deemed to be effectively a ‘cancelled customer.’ In which case, the system may support sending a notification to the first customer, if the reservation by the first customer has been forecasted to be effectively cancelled, wherein the notification confirms the cancellation of the reservation made by the first customer. If the reservation by the first customer has been conformed to be actually cancelled, the inventive system may support contacting the second customer through the mobile equipment of the second customer to incent the second customer to come earlier by offering the second customer a reduction of tips in exchange to come earlier than originally reserved.

In a different aspect of the invention, a mobile equipment of a third customer is provided. In which case, the inventive system is provided to reserve a table for use at a first reservation time by the first customer using the first mobile equipment. The system further allows reserving the table for use at a second reservation time by the second customer using the second mobile equipment; accepting the reservation by the first customer; accepting the reservation by the second customer; after accepting the reservation, sending a notification to remind the first customer that when a customer is late, additional charges will be incurred to the late customer as additional tips even though no penalties will be assessed directly to the first customer for being late.

Further, the inventive system determines if the first customer will be late as part of a process of dynamic Late Customers Forecasting, based on a set of criterion, including a history of the first customer. At a time when the first reservation time is fast approaching, the inventive system refines the process of dynamic Late Customers Forecasting by re-determining if the reservation by the first customer will be late, based on the set of criterion, including not only the history of the first customer but also a current location of the first customer. The system further supports prompting the first mobile equipment of the first customer for the current location of the first customer using GPS technologies and satellite communications exclusively without relying on GPRS and other means of cellular communications, as a means to save costs, calculating, based on the prompted location, distance between the current location of the first customer and the location of the restaurant; estimating, in a range, time for the first customer to arrive from the current location to the restaurant. If the estimated time to arrive at restaurant is later than the reserved time, then the first customer is deemed to be a late customer. If the estimated time to arrive at restaurant is much later than the reserved time, then the first customer is deemed to be effectively a ‘cancelled customer.’ In which case, the system may send a notification to the first customer, if the reservation by the first customer has been forecasted to be effectively cancelled, wherein the notification confirms the cancellation of the reservation made by the first customer. If the reservation by the first customer has been conformed to be actually cancelled, the system may support contacting the second customer and third customer through the mobile equipment of the second customer to incent both the second customer and the third customer to come earlier by offering the second customer and the third customer a reduction of tips in exchange to come earlier than originally reserved. If both the second customer and the third customer indicate their interests to accept the proposed reserved time, the system features allowing both the second customer and the third customer to bid for the proposed reserved time; and reducing the incentive further to attract either the second customer or the third customer who is willing to accept the proposed reserved time with the lowest incentive.

In another embodiment, GPS related technologies may be deployed to this inventive system. In one instance, a system may be provided, including features such as reserving a table for use at a first reservation time by the first customer using the first mobile equipment; reserving the table for use at a second reservation time by the second customer using the second mobile equipment; accepting the reservation by the first customer; and accepting the reservation by the second customer. After accepting the reservation, the system may send a notification to remind the first customer that when a customer is late, additional charges will be incurred to the late customer as additional tips even though no penalties will be assessed directly to the first customer for being late. The system may then determine if the first customer will be late as part of a process of dynamic Late Customers Forecasting, based on a set of criterion, including a history of the first customer.

At a time when the first reservation time is fast approaching, the inventive system may refine the process of dynamic Late Customers Forecasting by re-determining if the reservation by the first customer will be late, based on the set of criterion, including not only the history of the first customer but also a current location of the first customer; prompt the first mobile equipment of the first customer for the current location of the first customer using GPS technologies and satellite communications exclusively without relying on GPRS and other means of cellular communications, wherein if current GPS signals are not available because the first mobile equipment is being used in an indoor environment, location of last GPS signals before the first mobile equipment entering the indoor environment must be recorded previously by the first mobile equipment and is now reported in response to the prompting by the apparatus 120; calculating, based on the prompted location, distance between the current location of the first customer and the location of the restaurant; estimating, in a range, time for the first customer to arrive from the current location to the restaurant.

If the estimated time to arrive at restaurant is later than the reserved time, then the first customer is deemed to be a late customer. If the estimated time to arrive at restaurant is much later than the reserved time, then the first customer is deemed to be effectively a ‘cancelled customer.’ The system then can optionally send a notification to the first customer, if the reservation by the first customer has been forecasted to be effectively cancelled, wherein the notification confirms the cancellation of the reservation made by the first customer.

If the reservation by the first customer has been conformed to be actually cancelled, the inventive system may contact the second customer and third customer through the mobile equipment of the second customer to incent both the second customer and the third customer to come earlier by offering the second customer and the third customer a reduction of tips in exchange to come earlier than originally reserved.

If both the second customer and the third customer indicate their interests to accept the proposed reserved time, the system may support allowing both the second customer and the third customer to bid for the proposed reserved time; and reducing the incentive further to attract either the second customer or the third customer who is willing to accept the proposed reserved time with the lowest incentive.

While the invention has been shown and described with reference to particular embodiments thereof, it will be understood by those skilled in the art that the invention can be practiced, with modification, in other environments. For example, although the invention described above can be conveniently implemented in a general purpose computer selectively reconfigured or activated by software, those skilled in the art would recognize that the invention could be carried out in hardware, in firmware or in any combination of software, firmware or hardware including a special purpose apparatus specifically designed to perform the described invention. Therefore, changes in form and detail may be made therein without departing from the spirit and scope of the invention as set forth in the accompanying claims.

What is claimed is:

1. An online restaurant system for forecasting behaviors of late customers, comprising:
a mobile equipment of a first customer;
a mobile equipment of a second customer; and
an apparatus comprising a computing processing unit configured to process memory units stored to execute instructions by the processing unit.

2. The online restaurant system of claim 1, wherein the instructions comprise:
reserving a table for use at a first reservation time by the first customer using the first mobile equipment;
determining if the first customer will be late as part of a process of dynamic Late-Customers-Forecasting, based on a set of criterion, including a history of the first customer;
at a time when the first reservation time is fast approaching, refining the process of dynamic Late-Customers-Forecasting by re-determining if the first customer will be late, based on the set of criterion, including not only the history of the first customer but also a current location of the first customer;
determining, if the first customer has been forecasted to be late, how long the first customer will be late at the time when the first reservation time is approaching;
sending repeated warnings to the first customer, if the first customer has been forecasted to be late; and
if the first customer has been forecasted to be late, contacting the second customer through the mobile equipment of the second customer to make a different appointment with the second customer in order to avoid unnecessary delay introduced by the first customer, wherein the second customer has reserved the table for use at a time later than the first reservation time.

3. The online restaurant system of claim 1, wherein the instructions comprise:
reserving a table for use at a first reservation time by the first customer using the first mobile equipment;
accepting the reservation by the first customer;
after accepting the reservation, sending a notification to remind the first customer that when a customer is late, additional charges will be incurred to the late customer as additional tips even though no penalties will be assessed directly to the first customer for being late;
determining if the first customer will be late as part of a process of dynamic Late-Customers-Forecasting, based on a set of criterion, including a history of the first customer;
at a time when the first reservation time is fast approaching, refining the process of dynamic Late-Customers-Forecasting by re-determining if the first customer will be late, based on the set of criterion, including not only the history of the first customer but also a current location of the first customer;
determining, if the first customer has been forecasted to be late, how long the first customer will be late at the time when the first reservation time is approaching;
sending repeated warnings to the first customer, if the first customer has been forecasted to be late, wherein the warnings include the additional charges to be assessed as additional tips;
if the first customer has been forecasted to be late, contacting the second customer through the mobile equipment of the second customer to make a different appointment with the second customer in order to avoid unnecessary delay introduced by the first customer, wherein the second customer has reserved the table for use at a time later than the first reservation time; and
when the first customer arrives at the restaurant and determined to be actually late, charging the first customer for being late as additional tips.

4. The online restaurant system of claim 1, wherein the instructions comprise:
reserving a table for use at a first reservation time by the first customer using the first mobile equipment;
reserving the table for use at a second reservation time by the second customer using the second mobile equipment;
accepting the reservation by the first customer;
accepting the reservation by the second customer;
after accepting the reservation, sending a notification to remind the first customer that when a customer is late, additional charges will be incurred to the late customer as additional tips even though no penalties will be assessed directly to the first customer for being late;
determining if the first customer will be late as part of a process of dynamic Late-Customers-Forecasting, based on a set of criterion, including a history of the first customer;
at a time when the first reservation time is fast approaching, refining the process of dynamic Late-Customers-Forecasting by re-determining if the reservation by the first customer will be late, based on the set of criterion, including not only the history of the first customer but also a current location of the first customer;
determining whether the reservation by the first customer has been forecasted not only to be late, but to be effectively cancelled, based on the current location of the first customer and time remaining from the reservation time by the first customer;
sending a notification to the first customer, if the reservation by the first customer has been forecasted to be effectively cancelled, wherein the notification confirms the cancellation of the reservation made by the first customer; and
if the reservation by the first customer has been conformed to be actually cancelled, contacting the second customer through the mobile equipment of the second customer to incent the second customer to come earlier by offering the second customer a reduction of tips in exchange to come earlier than originally reserved.

5. The online restaurant system of claim 1, wherein the instructions comprise:
reserving a table for use at a first reservation time by the first customer using the first mobile equipment;
reserving the table for use at a second reservation time by the second customer using the second mobile equipment;
accepting the reservation by the first customer;
accepting the reservation by the second customer;
after accepting the reservation, sending a notification to remind the first customer that when a customer is late, additional charges will be incurred to the late customer as additional tips even though no penalties will be assessed directly to the first customer for being late;
determining if the first customer will be late as part of a process of dynamic Late-Customers-Forecasting, based on a set of criterion, including a history of the first customer;
at a time when the first reservation time is fast approaching, refining the process of dynamic Late-Customers-Forecasting by re-determining if the reservation by the first customer will be late, based on the set of criterion, including not only the history of the first customer but also a current location of the first customer;
calculating, based on the prompted location, distance between the current location of the first customer and the location of the restaurant;
estimating, in a range, time for the first customer to arrive from the current location to the restaurant;
If the estimated time to arrive at restaurant is later than the reserved time, then the first customer is deemed to be a late customer;
If the estimated time to arrive at restaurant is much later than the reserved time, then the first customer is deemed to be effectively a ‘cancelled customer;’
sending a notification to the first customer, if the reservation by the first customer has been forecasted to be effectively cancelled, wherein the notification confirms the cancellation of the reservation made by the first customer; and
if the reservation by the first customer has been conformed to be actually cancelled, contacting the second customer through the mobile equipment of the second customer to incent the second customer to come earlier by offering the second customer a reduction of tips in exchange to come earlier than originally reserved.

6. The online restaurant system of claim 1, wherein the instructions comprise:
reserving a table for use at a first reservation time by the first customer using the first mobile equipment;
reserving the table for use at a second reservation time by the second customer using the second mobile equipment;
accepting the reservation by the first customer;
accepting the reservation by the second customer;
after accepting the reservation, sending a notification to remind the first customer that when a customer is late, additional charges will be incurred to the late customer as additional tips even though no penalties will be assessed directly to the first customer for being late;
determining if the first customer will be late as part of a process of dynamic Late-Customers-Forecasting, based on a set of criterion, including a history of the first customer;
at a time when the first reservation time is fast approaching, refining the process of dynamic Late-Customers-Forecasting by re-determining if the reservation by the first customer will be late, based on the set of criterion, including not only the history of the first customer but also a current location of the first customer;
prompting the first mobile equipment of the first customer for the current location of the first customer using GPS technologies and satellite communications exclusively without relying on GPRS and other means of cellular communications;
calculating, based on the prompted location, distance between the current location of the first customer and the location of the restaurant;
estimating, in a range, time for the first customer to arrive from the current location to the restaurant;
If the estimated time to arrive at restaurant is later than the reserved time, then the first customer is deemed to be a late customer;
If the estimated time to arrive at restaurant is much later than the reserved time, then the first customer is deemed to be effectively a ‘cancelled customer;’
sending a notification to the first customer, if the reservation by the first customer has been forecasted to be effectively cancelled, wherein the notification confirms the cancellation of the reservation made by the first customer; and
if the reservation by the first customer has been conformed to be actually cancelled, contacting the second customer through the mobile equipment of the second customer to incent the second customer to come earlier by offering the second customer a reduction of tips in exchange to come earlier than originally reserved.

7. The online restaurant system of claim 1, wherein the system comprises a mobile equipment of a third customer and the instructions comprise:
reserving a table for use at a first reservation time by the first customer using the first mobile equipment;
reserving the table for use at a second reservation time by the second customer using the second mobile equipment;
accepting the reservation by the first customer;
accepting the reservation by the second customer;
after accepting the reservation, sending a notification to remind the first customer that when a customer is late, additional charges will be incurred to the late customer as additional tips even though no penalties will be assessed directly to the first customer for being late;
determining if the first customer will be late as part of a process of dynamic Late-Customers-Forecasting, based on a set of criterion, including a history of the first customer;
at a time when the first reservation time is fast approaching, refining the process of dynamic Late-Customers-Forecasting by re-determining if the reservation by the first customer will be late, based on the set of criterion, including not only the history of the first customer but also a current location of the first customer;
prompting the first mobile equipment of the first customer for the current location of the first customer using GPS technologies and satellite communications exclusively without relying on GPRS and other means of cellular communications, as a means to save costs,
calculating, based on the prompted location, distance between the current location of the first customer and the location of the restaurant;
estimating, in a range, time for the first customer to arrive from the current location to the restaurant;
If the estimated time to arrive at restaurant is later than the reserved time, then the first customer is deemed to be a late customer;
If the estimated time to arrive at restaurant is much later than the reserved time, then the first customer is deemed to be effectively a ‘cancelled customer;’
sending a notification to the first customer, if the reservation by the first customer has been forecasted to be effectively cancelled, wherein the notification confirms the cancellation of the reservation made by the first customer;
if the reservation by the first customer has been conformed to be actually cancelled, contacting the second customer and third customer through the mobile equipment of the second customer to incent both the second customer and the third customer to come earlier by offering the second customer and the third customer a reduction of tips in exchange to come earlier than originally reserved;
If both the second customer and the third customer indicate their interests to accept the proposed reserved time, allowing both the second customer and the third customer to bid for the proposed reserved time; and
reducing the incentive further to attract either the second customer or the third customer who is willing to accept the proposed reserved time with the lowest incentive.

8. The online restaurant system of claim 1, wherein the system comprises a mobile equipment of a third customer and the instructions comprise:
reserving a table for use at a first reservation time by the first customer using the first mobile equipment;
reserving the table for use at a second reservation time by the second customer using the second mobile equipment;
accepting the reservation by the first customer;
accepting the reservation by the second customer;
after accepting the reservation, sending a notification to remind the first customer that when a customer is late, additional charges will be incurred to the late customer as additional tips even though no penalties will be assessed directly to the first customer for being late;
determining if the first customer will be late as part of a process of dynamic Late-Customers-Forecasting, based on a set of criterion, including a history of the first customer;
at a time when the first reservation time is fast approaching, refining the process of dynamic Late-Customers-Forecasting by re-determining if the reservation by the first customer will be late, based on the set of criterion, including not only the history of the first customer but also a current location of the first customer;
prompting the first mobile equipment of the first customer for the current location of the first customer using GPS technologies and satellite communications exclusively without relying on GPRS and other means of cellular communications, wherein if current GPS signals are not available because the first mobile equipment is being used in an indoor environment, location of last GPS signals before the first mobile equipment entering the indoor environment must be recorded previously by the first mobile equipment and is now reported in response to the prompting by the apparatus;
calculating, based on the prompted location, distance between the current location of the first customer and the location of the restaurant;
estimating, in a range, time for the first customer to arrive from the current location to the restaurant;
If the estimated time to arrive at restaurant is later than the reserved time, then the first customer is deemed to be a late customer;
If the estimated time to arrive at restaurant is much later than the reserved time, then the first customer is deemed to be effectively a ‘cancelled customer;’
sending a notification to the first customer, if the reservation by the first customer has been forecasted to be effectively cancelled, wherein the notification confirms the cancellation of the reservation made by the first customer;
if the reservation by the first customer has been conformed to be actually cancelled, contacting the second customer and third customer through the mobile equipment of the second customer to incent both the second customer and the third customer to come earlier by offering the second customer and the third customer a reduction of tips in exchange to come earlier than originally reserved;
If both the second customer and the third customer indicate their interests to accept the proposed reserved time, allowing both the second customer and the third customer to bid for the proposed reserved time; and
reducing the incentive further to attract either the second customer or the third customer who is willing to accept the proposed reserved time with the lowest incentive.
